(19) United States
(12) Patent Application Publication
(10) Pub. No.: US 2009/0265942 A1
(43) Pub. Date: Oct. 29, 2009

(54) Hair clippers and reversibly attachable plates therefor

(76) Inventor: Ana Miriam Beltran, Margate, FL (US)

Correspondence Address: Ana Miriam Beltran / Entering the Artzone, P.O. Box 670012, Coral Springs, FL, 33067, US

(21) Appl. No.: 12/150,353

(22) Filed: Apr. 28, 2008

(51) Int. Cl. B26B 19/00; B26B 13/00

(52) U.S. Cl. 30/201; 30/233

(57) ABSTRACT

According to certain embodiments of the invention, hair clippers are provided that comprise a hair cutting end and a body portion having an area adapted to be held by a user. The area adapted to be held by a user preferably comprises a material having desirably low thermal conductivity properties, which is effective to reduce the amount of heat that is transferred to a user's hand during prolonged operation of the clipper. In addition, in certain embodiments, the invention provides that the area adapted to be held by a user preferably comprises a raised three-dimensional configuration, which is effective to provide the user with an enhanced grip of the clipper.

### FIELD OF THE INVENTION

The field of the present invention relates to hair clippers and attachable plates therefor.

### BACKGROUND OF THE INVENTION

Electric hair clippers are among the most common tools used by hair stylists and barbers. Indeed, most are familiar with the electric hair clippers that are used to cut or shave hair to a desired length, as often used by hair care professionals. Most of these clippers comprise a metallic outer shell, which house a motor and the other electrical and mechanical parts that are necessary to cause a set of blades at one of the clipper to produce a clipping or cutting motion.

Unfortunately, these commonly-used hair clippers suffer from a few drawbacks. For example, the metallic outer shall often becomes very hot during prolonged use, which is partly attributable to its close proximity to the internal motor and other elements that generate heat. In addition, the currently-available clippers generally comprise a relatively smooth (planar) surface, which often makes the clippers slippery and difficult to handle (especially when a user's hands are wet from perspiration caused by the excessive heat generated by the clipper).

In view of the foregoing, a need exists for improved hair clippers and appliances therefor.

### SUMMARY OF THE INVENTION

According to a first aspect of the invention, a hair clipper is provided that comprises a hair cutting end and a body portion having an area adapted to be held by a user. The area adapted to be held by a user preferably comprises a material having poor thermal conductivity properties, which is effective to reduce the amount of heat that is transferred to a user's hand during prolonged operation of the clipper. In addition, in certain embodiments, the invention provides that the area adapted to be held by a user preferably comprises a raised three-dimensional configuration, which is effective to provide the user with an enhanced grip of the clipper, as well as potentially enhance the appearance of the clipper.

According to a second aspect of the invention, plates are provided that are adapted to be reversibly attached to a body portion of a hair clipper. The separate plates of the present invention preferably comprise a material having poor thermal conductivity properties, which is effective to reduce the amount of heat that is transferred to a user's hand during prolonged operation of the clipper. In addition, according to certain embodiments of the present invention, the separate plates may comprise a raised three-dimensional configuration, which may provide a user with an enhanced grip of the clipper. Still further, in certain embodiments, the raised three-dimensional configuration may exhibit any of various graphical designs or other aesthetically-attractive configurations.

According to a third aspect of the invention, methods for reducing the amount of heat transferred from an electric hair clipper to a user's hands are provided. In addition, methods for improving the grip of an electric hair clipper are provided. These methods generally comprise attaching one or more separate plates described herein to the body portion of a hair clipper, or otherwise producing the body portion of a hair clipper to comprise a material that exhibits a preferably low thermal conductivity value.

According to a fourth aspect of the invention, kits are provided for enhancing the grip (and/or appearance) of an electric hair clipper. The kits of such embodiments will generally comprise one or more separate plates described herein, which may be reversibly attached to the body portion of a hair clipper. The kits may further comprise on or more attachment means, such as one or more screws, for reversibly attaching a plate to the body portion of a hair clipper.

The above-mentioned and additional features of the present invention are further illustrated in the Detailed Description contained herein.

### BRIEF DESCRIPTION OF THE FIGURES

FIG. 1 is a perspective view of a hair clipper of the present invention.

FIG. 2 is a side view of the hair clipper of FIG. 1.

FIG. 3 is a front view of a separate plate that may be reversibly attached to the hair clipper of FIG. 1.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

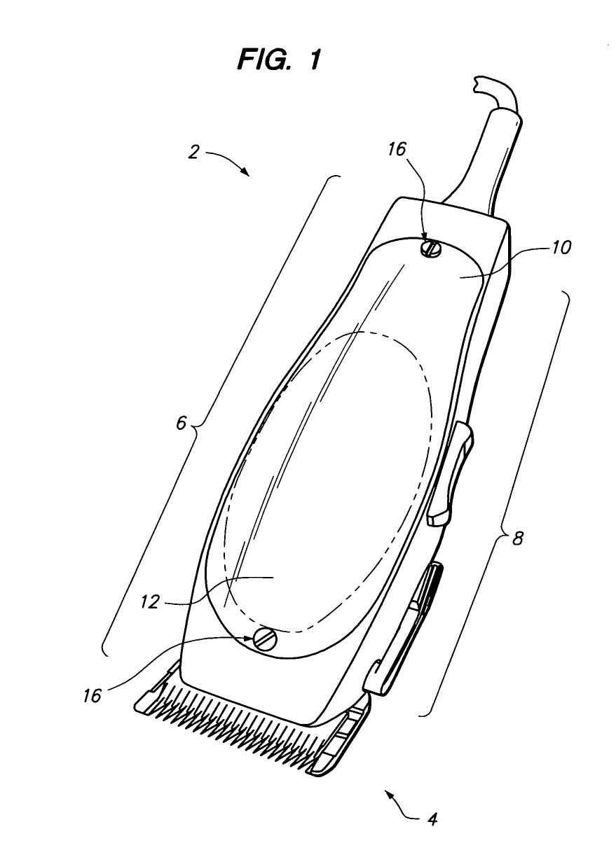

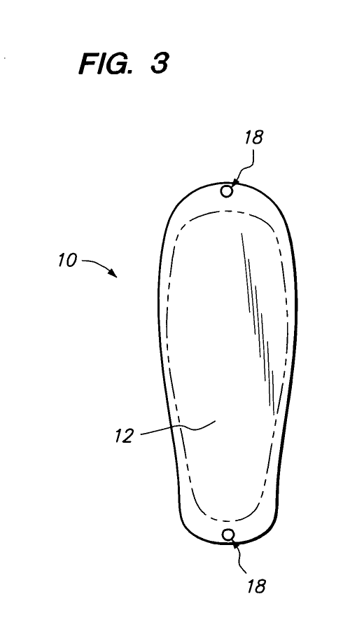

According to certain embodiments of the invention, and referring to FIG. 1, a hair clipper 2 is provided that comprises a hair cutting end 4 and a body portion 6 having an area 8 adapted to be held by a user. The area 8 adapted to be held by a user preferably comprises a material having poor or relatively low thermal conductivity properties. The low thermal conductive properties will, preferably, cause such material to operate as a heat insulator, and reduce the amount of heat that is transferred to a user's hand during prolonged operation of the clipper 2. The area 8 adapted to be held by a user, which preferably comprises a material having poor thermal conductivity properties, may be integrally formed with the body portion 6 or, as described further below, may be comprised of a separate plate 10 that is reversibly attached to the body portion 6 of the clipper 2, as shown in FIG. 3.

Thermal conductivity, often represented by the variable “K,” is the property of a material that indicates its ability to conduct heat. According to the present invention, materials that are less capable of conducting heat are preferred for use in constructing the area 8 adapted to be held by a user of a clipper 2, insofar as the material will preferably operate as a barrier and insulator and reduce the amount of heat transferred from, for example, the motor of a hair clipper 2 to a user's hands. This will increase the level of comfort that a user will experience during operation, avoid “burning” an operator's hands (which sometimes occurs with certain prior art clippers), and reduce perspiration that would otherwise accumulate on a user's hands in response to such excessive heat (which further imparts an enhanced grip to the clipper).

The thermal conductivity properties of most materials are well-known. For example, it is known that non-metals, e.g., glass, cement, rubber, etc., do not conduct heat as well as most metallic materials. However, even within the class of metallic materials, certain types of metals and alloys will conduct heat better than others. For example, alloys generally do not conduct heat as efficiently as pure metals. Examples of pure metals with relatively high and undesirable thermal conductivity values include aluminum, copper, and silver.

The metric units for thermal conductivity values are Watts per meter per degree Celsius (C), which is typically expressed as W/(m·K). The following equation provides the means by which the thermal conductivity value of a material is calculated:

$$k = \frac{Δ Q}{Δ t} \times \frac{1}{A} \times \frac{x}{Δ T}$$

According to the equation above, the following variables have the following meanings:

ΔQ /Δt=the rate of heat flow;

K=thermal conductivity;

A=total surface area of conducting surface; and

ΔT=is the temperature difference and x is the thickness of a conducting surface separating the two temperatures.

As mentioned above, the thermal conductivity values of a wide variety of different materials have been established. The table below provides a list of exemplary materials and the corresponding thermal conductivity values (or ranges thereof) which have been reported.

| | Thermal conductivity |
|---|---|
| Material | (W · m⁻¹ · K⁻¹) |
| Silver, pure | 406-429 |
| Copper, pure | 353-386 |
| Gold, pure | 314-318 |
| Beryllium oxide | 218 |
| Aluminium, pure | 205-237 |
| Aluminium nitride | 170 |
| Brass (63% Cu) | 125 |
| Brass (70% Cu) | 109-121 |
| Iron, pure | 71.8-80.4 |
| Cast iron | 55 |
| Steel(normal) | 50.2 |
| Alumina, pure | 40 |
| Carbon steel | 36-54 |
| Bronze | 26-50 |
| Zinc oxide | 21 |
| Stainless steel | 16.3 |
| Titanium, pure | 15.6-21.9 |
| Titanium Alloy | 5.8 |
| Marble | 2.07-2.94 |
| Sandstone | 1.83-2.90 |
| Granite | 1.73-3.98 |
| Limestone | 1.26-1.33 |
| Concrete | 0.8-1.28 |
| Glass | 0.8-0.93 |
| Polymer, High-Density | 0.33-0.52 |
| Plastic, fiber-reinforced | 0.23-1.06 |
| Rubber (92%) | 0.16 |
| Wood, +>=12% water | 0.0909-0.4 |
| Cork | 0.04-0.07 |
| Polymer, Low-density | 0.04-0.33 |

According to certain preferred embodiments, the material used to construct the area 8 adapted to be held by a user preferably has a thermal conductivity value of no more than 150 W/(m·K). More preferably, the material has a thermal conductivity value of no more than 100 W/(m·K) or, even more preferably, no more than 50 W/(m·K) or, still more preferably, no more than 25 W/(m·K). The material used to construct the area 8 adapted to be held by a user may include, for example, pure alumina, carbon steel, bronze, zinc oxide, zinc alloys, stainless steel, pure titanium, titanium alloy, marble, sandstone, granite, limestone, concrete, glass, high-density polymer, plastic, fiber-reinforced plastic, rubber, wood, cork, low-density polymer, and combinations thereof. According to certain preferred embodiments, the area 8 is made of zinc oxide, zinc alloy, or a combination thereof, as such zinc-based materials have been shown to exhibit desirable heat insulation properties (i.e., sufficiently low thermal conductivity properties) and to be easy to modify into an aesthetically-desirable configuration.

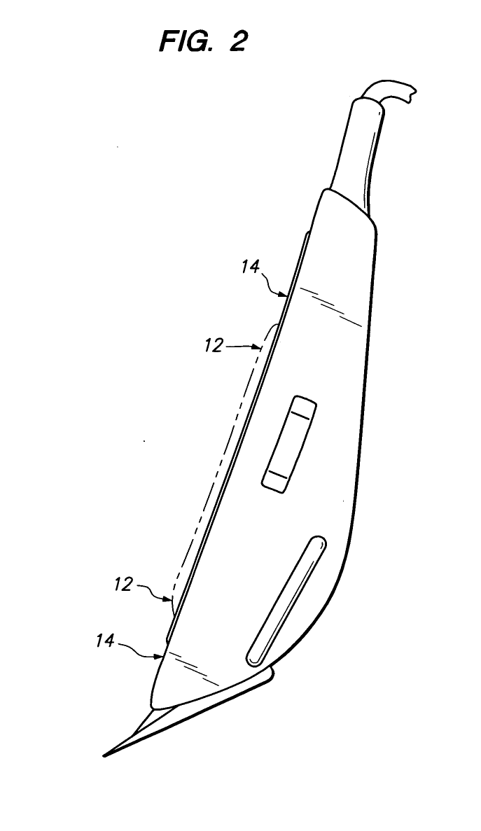

According to certain additional embodiments, and referring to FIGS. 1 and 2, the invention provides that the area 8 adapted to be held by a user may comprise a raised three-dimensional configuration 12, which is effective to provide the user with an enhanced grip of the clipper 2. More particularly, referring to FIG. 2, the raised three-dimensional configuration 12 will, preferably, extend some distance above the plane 14 of the body portion 6. According to such embodiments, the area 8 having the raised three-dimensional configuration 12 is capable of providing an enhanced grip to the user compared to a material having a substantially planar configuration, i.e., compared to a clipper having an area 8 that is substantially contiguous with (or is substantially planar with) the remainder of the body portion 6.

The raised three-dimensional configuration 12 may exhibit any design, configuration, shape, or size. In certain embodiments, for example, the raised three-dimensional configuration 12 may comprise grids, channels, or other elements to impart more friction to a user's hands, thereby improving the grip of such area 8. As used herein, the term “grip” generally refers to the area 8 adapted to be held by a user of the clipper and the level of ease with which a user may grasp, hold, and maneuver a hair clipper associated therewith.

The invention further provides that the raised three-dimensional configuration 12 may comprise a creative or aesthetically-desirable design, such as logos, renderings, a person's initials, or other sculpted images that produces a desirable appearance and, furthermore, comprises various undulations therein (e.g., ridges or other elements) to simultaneously provide the area 8 adapted to be held by a user with an enhanced grip.

According to further embodiments of the invention, and referring to FIG. 3, separate plates 10 are provided that are adapted to be reversibly attached to a body portion 6 of a hair clipper 2 (as shown, for example, in FIGS. 1 and 2). Similar to the other embodiments described herein, the separate plates 10 of the present invention preferably comprise a material having poor thermal conductivity properties, such that the separate plates 10 will be effective to reduce the amount of heat that is transferred (from the body portion 6 of the clipper 2 and motor contained therein) to a user's hand during prolonged operation of the clipper 2. More specifically, as with the other embodiments described above, the invention provides that the separate plates 10 are comprised of a material that preferably has a thermal conductivity value of no more than 150 W/(m·K), and more preferably no more than 100 W/(m·K) or, even more preferably, no more than 50 W/(m·K), such as 25 W/(m·K) or less. The separate plates 10 may be entirely, or partly, constructed of any of the materials described above.

In addition, according to certain embodiments of the present invention, the separate plates 10 will preferably comprise the raised three-dimensional configuration 12 described herein, which may provide a user with an enhanced grip of the clipper. The separate plates 10 will preferably further comprise a means of reversibly (or permanently) attaching the separate plates 10 to a body portion 6 of a hair clipper 2. Non-limiting examples of such means include screws, magnets, snaps, adhesives, other mechanical attachment means, and combinations thereof. According to certain preferred embodiments, the separate plates 10 are reversibly attached to a body portion 6 of a hair clipper 2 using one or more screws 16 (FIG. 1). For example, the body portion 6 of a hair clipper 2 may include one or more threaded holes (not shown) which are adapted to receive a correspondingly-shaped and threaded screw, such that a screw 16 may be disposed through an aperture 18 (FIG. 3) located in a separate plate 10, inserted into such hole located in the body portion 6 of a hair clipper 2, and tightened to reversibly attach the separate plate 10 thereto.

Although the foregoing embodiments describe, and FIGS. 1-3 show, a hair clipper 2 having an area 8 adapted to be held by a user (which comprises the material having a preferably low thermal conductivity value and/or raised three-dimensional configuration 12 described herein) on a single side of the hair clipper 2 (i.e., on the top side of the hair clipper 2), the invention provides that such material having a preferably low thermal conductivity value and/or raised three-dimensional configuration 12 may also be located on the side portions and/or bottom side of the hair clipper 2. According to such embodiments, the additional material may be integrally formed with the body portion 6 of the clipper 2 or, as described herein, may be configured as separate plates which may be reversibly (or permanently) attached to the side portions and/or bottom side of the clipper 2.

According to further embodiments of the present invention, methods for reducing the amount of heat transferred from an electric hair clipper to a user's hands are provided. In addition, methods for improving the grip of an electric hair clipper are provided. These methods generally comprise producing a body portion 6 of a hair clipper 2 or, more specifically, an area 8 thereof adapted to be held by a user to be comprised of a material that exhibits a preferably low thermal conductivity value and/or raised three-dimensional configuration 12, as described herein. Alternatively, such methods generally comprise attaching one or more of the separate plates 10 described herein to an area 8 of a hair clipper 2 that is adapted to be held by a user.

According to yet further embodiments of the present invention, kits are provided for enhancing the grip of an electric hair clipper—and enhancing the aesthetic appearance thereof. The kits of such embodiments will generally comprise one or more separate plates 10 described herein, which may be reversibly attached to the body portion 6 of a hair clipper 2. The kits may further comprise one or more attachment means, such as one or more screws 16, for reversibly attaching a plate 10 to the body portion 6 of a hair clipper 2.

It is to be understood that both the general description and the detailed description are exemplary and explanatory, but are not restrictive of the invention. The invention in its broader aspects is not limited to the specific details shown and described, and departures may be made from such details without departing from the principles of the invention and without sacrificing its chief advantages.

What is claimed is:

1. A hair clipper, which comprises:
(a) a hair cutting end; and
(b) a body portion having an area adapted to be held by a user, wherein the area comprises a material having poor thermal conductivity properties.

2. The hair clipper of claim 1, wherein the material has a thermal conductivity value of no more than 150 W/(m·K).

3. The hair clipper of claim 2, wherein the material exhibits a raised three-dimensional configuration.

4. The hair clipper of claim 3, wherein the material having the raised three-dimensional configuration is capable of providing an enhanced grip to the user compared to a material having a substantially planar configuration.

5. The hair clipper of claim 4, wherein the material is configured as a separate plate.

6. The hair clipper of claim 5, wherein the separate plate is configured to be attached to the area adapted to be held by the user.

7. The hair clipper of claim 5, wherein the separate plate is configured to be reversibly attached to the area adapted to be held by the user.

8. The hair clipper of claim 5, wherein the material has a thermal conductivity value of no more than 100 W/(m·K).

9. The hair clipper of claim 5, wherein the material has a thermal conductivity value of no more than 50 W/(m·K).

10. The hair clipper of claim 9, wherein the material has a thermal conductivity value of no more than 25 W/(m·K).

11. The hair clipper of claim 9, wherein the material is selected from the group consisting of: pure alumina, carbon steel, bronze, zinc oxide, zinc alloy, stainless steel, pure titanium, titanium alloy, marble, sandstone, granite, limestone, concrete, glass, high-density polymer, plastic, fiber-reinforced plastic, rubber, wood, cork, low-density polymer, and combinations of the foregoing.

12. The hair clipper of claim 11, wherein the material is zinc oxide, zinc alloy, or a combination thereof.

13. The hair clipper of claim 12, wherein the separate plate is attached to the body portion using one or more screws.

14. A hair clipper, which comprises:
(a) a hair cutting end; and
(b) a body portion comprising an area that is adapted to be held by a user and a region adapted to receive a separate plate, wherein:
(i) the plate consists essentially of zinc oxide, zinc alloy, or a combination thereof; and
(ii) the plate comprises a raised three-dimensional configuration that is capable of providing an enhanced grip to the user compared to a plate having a substantially planar configuration.

15. A plate that is adapted to be reversibly attached to a body portion of a hair clipper, which comprises a material having poor thermal conductivity properties and a raised three-dimensional configuration.

16. The plate of claim 15, wherein the plate having the raised three-dimensional configuration is capable of providing an enhanced grip to a user compared to a plate having a substantially planar configuration.

17. The plate of claim 16, wherein the material has a thermal conductivity value of no more than 50 W/(m·K).

18. The plate of claim 17, wherein the material has a thermal conductivity value of no more than 25 W/(m·K).

19. The plate of claim 17, wherein the material is selected from the group consisting of: pure alumina, carbon steel, bronze, zinc oxide, zinc alloy, stainless steel, pure titanium, titanium alloy, marble, sandstone, granite, limestone, concrete, glass, high-density polymer, plastic, fiber-reinforced plastic, rubber, wood, cork, low-density polymer, and combinations thereof.

20. The plate of claim 19, wherein the material is zinc oxide, zinc alloy, or combinations thereof.
